(19) United States
(12) Patent Application Publication
(10) Pub. No.: US 2025/0028143 A1
(43) Pub. Date: Jan. 23, 2025

(54) DRIVING MECHANISM

(71) Applicant: TDK TAIWAN CORP., Taoyuan City (TW)

(72) Inventors: Po-Xiang ZHUANG, Taoyuan City (TW); Yi-Fan LEE, Taoyuan City (TW); Chao-Yuan CHANG, Taoyuan City (TW); Wei-Jhe SHEN, Taoyuan City (TW); Sin-Jhong SONG, Taoyuan City (TW); Kun-Shih LIN, Taoyuan City (TW); Yi-Ho CHEN, Taoyuan City (TW); Chao-Chang HU, Taoyuan City (TW)

(21) Appl. No.: 18/768,209

(22) Filed: Jul. 10, 2024

Related U.S. Application Data
(60) Provisional application No. 63/514,958, filed on Jul. 21, 2023.

(51) Int. Cl. G02B 7/08; G02B 27/64

(52) U.S. Cl. CPC G02B 7/08; G02B 27/646

(57) ABSTRACT

A driving mechanism for moving an optical element is provided, including a fixed part, a movable part, a driving assembly, and a first guiding member connected between the fixed part and the movable part. The optical element is disposed on the movable part, and the driving assembly drives the movable part to move relative to the fixed part. The first guiding member is configured for guiding the movable part to move relative to the fixed part.

### CROSS REFERENCE TO RELATED APPLICATIONS

This application claims the benefit of U.S. Provisional Application No. 63/514,958, filed Jul. 21, 2023, the entirety of which is incorporated by reference herein.

### BACKGROUND OF THE INVENTION

### Field of the Invention

The present invention relates to a driving mechanism, and, in particular, to a driving mechanism for moving an optical element.

### Description of the Related Art

As technology has advanced, a lot of electronic devices (for example, laptop computers and smartphones) have incorporated the functionality of taking photographs and recording video. These electronic devices have become more commonplace, and have been developed to be more convenient and thin. More and more options are provided for users to choose from.

Some electronic devices use coils and magnets to adjust the focus of a lens. However, miniaturization of these electronic devices may increase the difficulty of mechanical design, and it may also lead to low reliability and low driving force for moving the lens. Addressing these problems has become a challenge.

### BRIEF SUMMARY OF THE INVENTION

An embodiment of the present invention provides a driving mechanism for moving an optical element that has an optical axis. The driving mechanism includes a fixed part, a movable part, and a driving assembly. The movable part is movably connected to the fixed part for holding the optical element. The driving assembly is configured for moving the movable part relative to the fixed part.

In some embodiments, the driving mechanism further includes a first guiding member disposed on the fixed part and connected to the movable part for guiding the movable part to move relative to the fixed part along the optical axis.

In some embodiments, the driving mechanism further includes a first magnet disposed on the movable part, wherein the movable part has a first recessed portion, and the first magnet and the first guiding member produce a first magnetic attractive force, whereby the first guiding member remains in contact with the first recessed portion.

In some embodiments, the driving mechanism further includes a first shield disposed on the movable part and concealing the first magnet, wherein the first shield is located between the first guiding member and the first magnet.

In some embodiments, the first shield includes metal with low magnetic permeability (approximately 0).

In some embodiments, a gap is formed between the first shield and the first guiding member.

In some embodiments, the movable part further has a first protrusion, the first shield has a first slot, and the first protrusion is joined in the first slot.

In some embodiments, the first magnet includes a monopolar, bipolar or multipolar magnet.

In some embodiments, the polar direction of the first magnet is parallel to the first axis, which is perpendicular to the optical axis.

In some embodiments, a line extending through the centers of the first magnet and the first guiding member is parallel to the first axis.

In some embodiments, the first recessed portion of the holder has a V-shaped structure.

In some embodiments, the driving mechanism further includes a second guiding member disposed on the fixed part and connected to the movable part for guiding the movable part to move relative to the fixed part along the optical axis, wherein the first and second guiding members are located at opposite corners of the fixed part.

In some embodiments, the driving mechanism further includes a second magnet disposed on the movable part, wherein the movable part has a second recessed portion, and the second magnet and the second guiding member produce a second magnetic attractive force, whereby the second guiding member remains in contact with an abutting surface of the second recessed portion.

In some embodiments, the driving mechanism further includes a second shield disposed on the movable part and concealing the second magnet, wherein the abutting surface is located between the second guiding member and the second magnet.

In some embodiments, the movable part further has a second protrusion, the second shield has a second slot, and the second protrusion is joined in the second slot.

In some embodiments, the polar direction of the first and second magnets is parallel to the first axis and perpendicular to the optical axis.

In some embodiments, the abutting surface is a flat surface perpendicular to the first axis.

In some embodiments, the fixed part has a first column and a second column, the first guiding member is affixed to the first column, and the second guiding member is affixed to the second column.

In some embodiments, the first column and the second column are located at opposite corners of the fixed part.

In some embodiments, at least a part of the second column is received in the second recessed portion.

### BRIEF DESCRIPTION OF THE DRAWINGS

The present invention can be more fully understood by reading the subsequent detailed description and examples with references made to the accompanying drawings, wherein:

FIG. 1 shows an exploded view of a driving mechanism 100 in accordance with an embodiment of the invention.

FIG. 2 shows another exploded view of the driving mechanism 100 in FIG. 1.

FIG. 3 shows a perspective diagram of the driving mechanism 100 in FIGS. 1 and 2 after assembly.

FIG. 4 shows another perspective diagram of the driving mechanism 100 in FIGS. 1 and 2 after assembly.

FIG. 5 is an exploded view showing the first magnetic unit m1 and the second magnetic unit m2 before assembled to the holder LH.

FIG. 6 is a perspective diagram showing the first magnetic unit m1 and the second magnetic unit m2 when assembled to the holder LH.

FIG. 7 is another perspective diagram showing the first magnetic unit m1 and the second magnetic unit m2 when assembled to the holder LH.

FIG. 8 is a top view of the driving mechanism 100 shown in FIGS. 3 and 4 with the housing H and the frame F removed therefrom.

FIG. 9 is an enlarged view of the area A1 in FIG. 8.

FIG. 10 is an enlarged view of the area A2 in FIG. 8.

FIG. 11 shows an exploded view of the first magnetic unit m1.

FIG. 12 is a perspective diagram showing the first magnetic unit m1 disposed in the first cavity LH1′ of the holder LH.

FIG. 13 shows an exploded view of the second magnetic unit m2.

FIG. 14 is a perspective diagram showing the second magnetic unit m2 disposed in the second cavity LH2′ of the holder LH.

### DETAILED DESCRIPTION OF THE INVENTION

The making and using of the embodiments of the driving mechanism are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

In the following detailed description of the preferred embodiments, reference is made to the accompanying drawings, and in which specific embodiments of which the invention may be practiced are shown by way of illustration. In this regard, directional terminology, such as “top,” “bottom,” “left,” “right,” “front,” “back,” etc., is used with reference to the orientation of the figures being described. The components of the present invention can be positioned in a number of different orientations. As such, the directional terminology is used for the purposes of illustration and is in no way limiting.

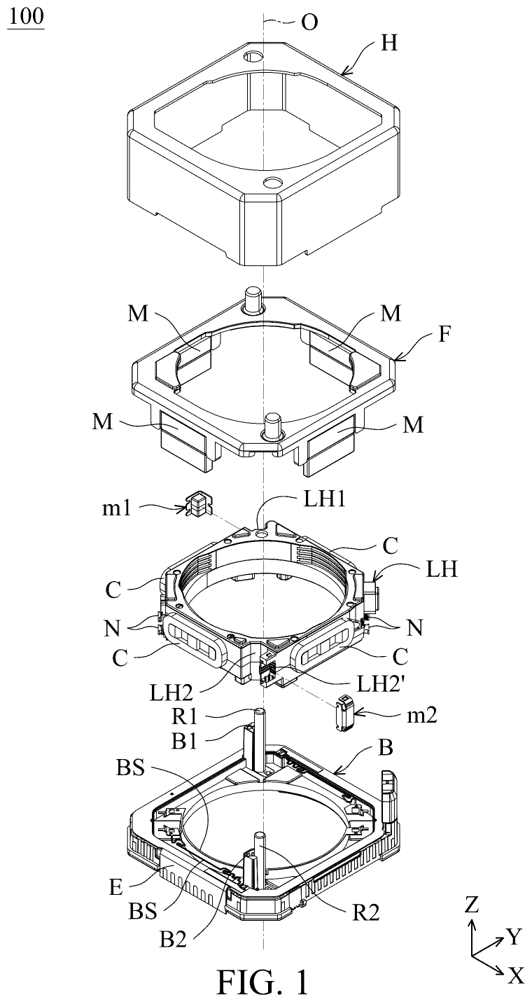

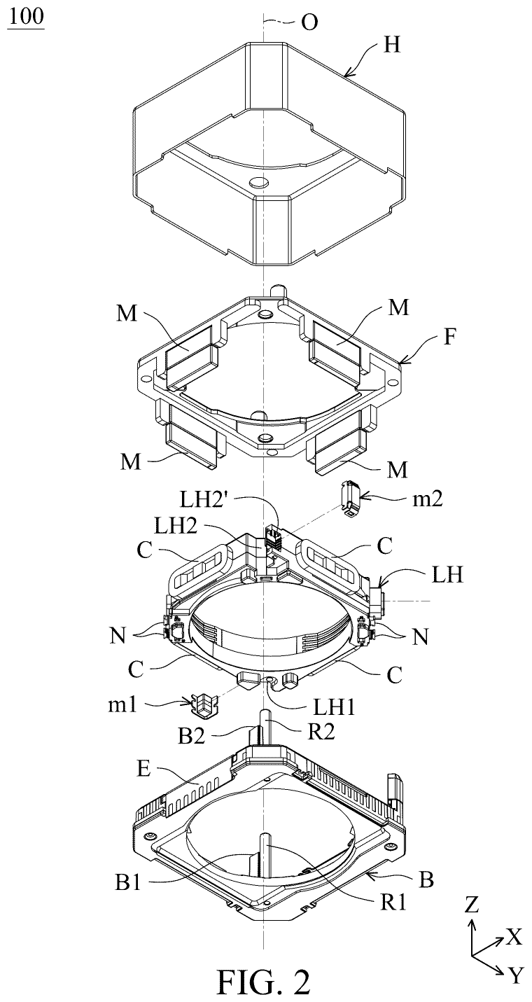

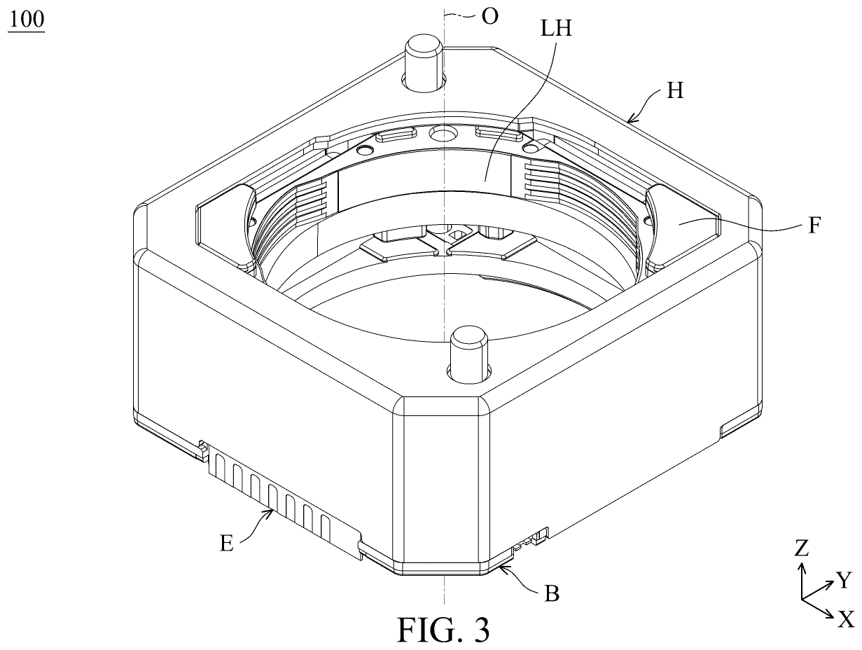

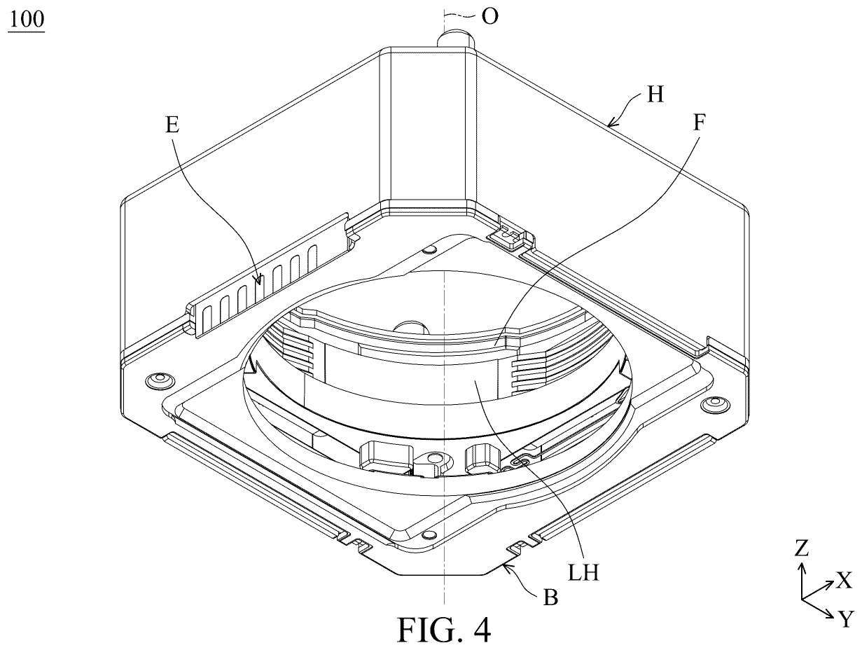

FIG. 1 shows an exploded view of a driving mechanism 100 in accordance with an embodiment of the invention. FIG. 2 shows another exploded view of the driving mechanism 100 in FIG. 1. FIG. 3 shows a perspective diagram of the driving mechanism 100 in FIGS. 1 and 2 after assembly. FIG. 4 shows another perspective diagram of the driving mechanism 100 in FIGS. 1 and 2 after assembly.

Referring to FIGS. 1-4, the driving mechanism 100 in this embodiment is a Voice Coil Motor (VCM) which may be disposed in a cell phone or other portable electronic device (e.g. camera) for driving an optical element (e.g. optical lens) to move, thereby achieving the function of auto-focusing (AF) or Optical Image Stabilization (OIS).

The driving mechanism 100 primarily comprises a hollow housing H, a polygonal plastic base B, a first guiding member R1, a second guiding member R2, a circuit assembly E (e.g. flexible circuit board), at least a lower sheet spring BS, a holder LH, a frame F, at least a magnetic element M, at least a coil C, a first magnetic unit m1, and a second magnetic unit m2.

The housing H has a hollow structure affixed to the base B. Here, the housing H and the base B form a fixed part of the driving mechanism 100. The circuit assembly E is disposed on the top surface of the base B and surrounds the optical axis O of the optical element. The lower sheet spring BS is disposed on the top surface of the base B and connected to the holder LH. The circuit assembly E can be electrically connected to the coils C on the holder LH via the lower sheet spring BS to form a circuit loop.

The holder LH is movably received in the housing H, and an optical element (not shown) is affixed in the holder LH. The holder LH forms a movable part that can move relative to the fixed part (the housing H and the base B).

It should be noted that the holder LH is suspended within the driving mechanism 100 by the lower sheet springs BS connected between the base B and the holder LH. With the configuration as described above, external light can enter the driving mechanism 100 along the optical axis O of the optical element, and light can propagate through the optical element to an image sensor (not shown) below the base B to form a digital image.

The frame F is adhered to the inner surface of the housing H, and four magnetic elements M (e.g. magnets) are disposed on the four sides of the frame F. Additionally, four coils C are disposed on four sides of the holder LH and located in a location that corresponds to the magnetic elements M. The coils C and the magnetic elements M constitute a driving assembly for impelling the movable part (the holder LH) relative to the fixed part (the housing H and the base B) along the optical axis O.

When a current signal is applied to the coils C, an electromagnetic force can be generated by the coils C and the magnets M, so that the holder LH and the optical element received therein are driven to move relative to the fixed part (the housing H and the base B) along the optical axis O (Z direction). Hence, the function of auto-focusing (AF) or Optical Image Stabilization (OIS) can be achieved.

As shown in FIGS. 1 and 2, the first guiding member R1 and the second guiding member R2 comprise longitudinal rods affixed to the base B. The base B forms a first column B1 and a second column B2 extending along the optical axis O (Z direction). The first guiding member R1 is located at a corner of the base B and abuts the first column B1. The second guiding member R2 is located at another corner of the base B and abuts the second column B2. Here, the first and second columns B1 and B2 are located on opposite sides of the holder LH.

Moreover, the holder LH has a first recessed portion LH1 and a second recessed portion LH2, corresponding to the first and second guiding members R1 and R2. After assembly of the driving mechanism 100, the first guiding member R1 is connected between the first column B1 and the first recessed portion LH1, and the second guiding member R2 is connected between the second column B2 and the second recessed portion LH2. The first and second guiding members R1 and R2 are configured for guiding the holder LH to slide relative to the fixed part (the housing H and the base B) along the optical axis O (Z direction).

In some embodiments, the first magnetic unit m1 and the second magnetic unit m2 are disposed at two opposite corners of the holder LH, and they can be magnetically attached to the first and second guiding members R1 and R2 on the base B after assembly.

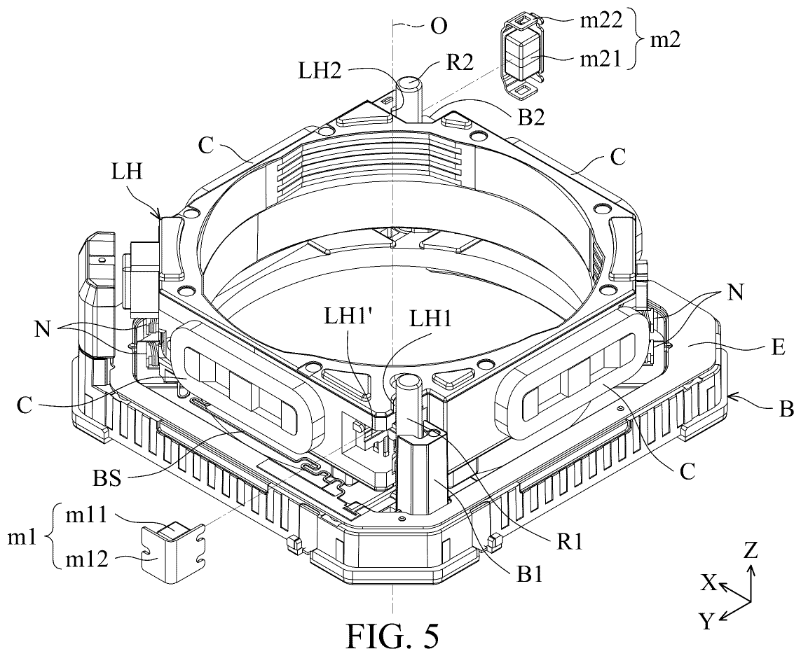

FIG. 5 is an exploded view showing the first magnetic unit ml and the second magnetic unit m2 before assembled to the holder LH.

Referring to FIG. 5, two pairs of winding posts N are formed at opposite corners of the holder LH. During assembly, one end of four wires (not shown) can be wound around the winding posts N, and the other end of the wires can be connected to the four coils C. The wires wound on the winding posts N can be electrically connected to the lower sheet spring BS beneath the winding posts N by soldering or welding, whereby the electrical current signal can be transferred from the circuit assembly E to the coils C through the sheet springs BS.

It can be seen in FIG. 5 that the first magnetic unit m1 includes a first magnet m11 and a first shield m12, and the second magnetic unit m2 includes a second magnet m21 and a second shield m22. The first magnet m11 is disposed in a first cavity LH1′ of the holder LH, and the second magnet m21 is disposed in a second cavity LH2′ of the holder LH (FIGS. 1 and 2).

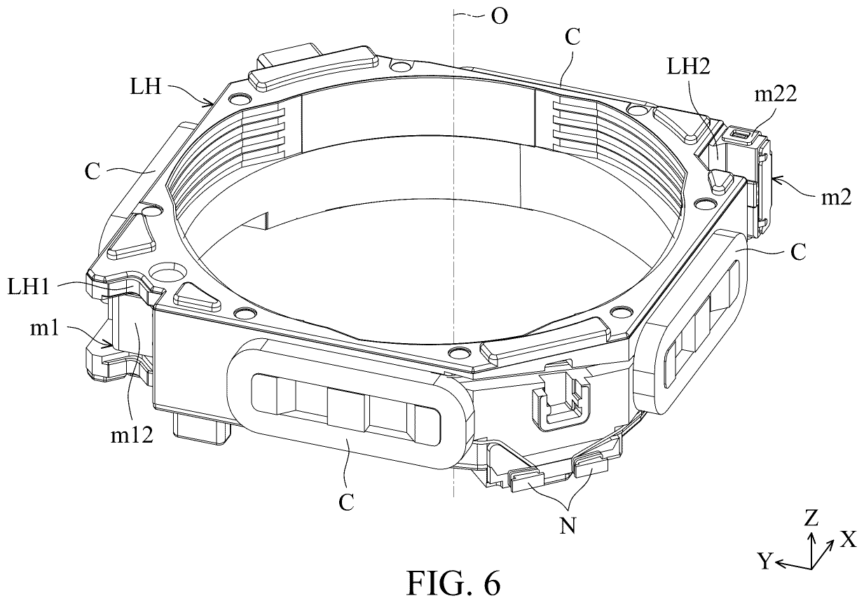

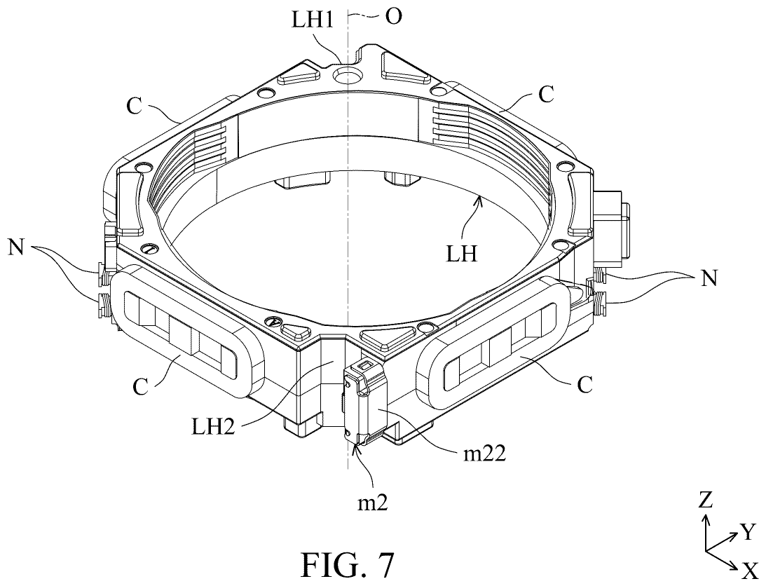

FIG. 6 is a perspective diagram showing the first magnetic unit m1 and the second magnetic unit m2 when assembled to the holder LH. FIG. 7 is another perspective diagram showing the first magnetic unit m1 and the second magnetic unit m2 when assembled to the holder LH.

Referring to FIG. 6, the first magnetic unit m1 is located close to the first recessed portion LH1, and the first magnet m11 is concealed by the first shield m12 after assembly, whereby the first magnet m11 is prevented from being exposed to the outside.

Similarly, as shown in FIGS. 6 and 7, the second magnetic unit m2 is located close to the second recessed portion LH2, and the second magnet m21 is concealed by the second shield m22 after assembly, whereby the second magnet m21 is prevented from being exposed to the outside.

For example, the first and second magnets m12 and m21 may comprise monopolar, bipolar or multipolar magnets. The first and second shields m11 and m22 may comprise metal that has low magnetic permeability for protecting and positioning the first and second magnets m11 and m21. In some embodiments, the first and second shields m12 and m22 may comprise low-density material to achieve lightweight of the driving mechanism 100.

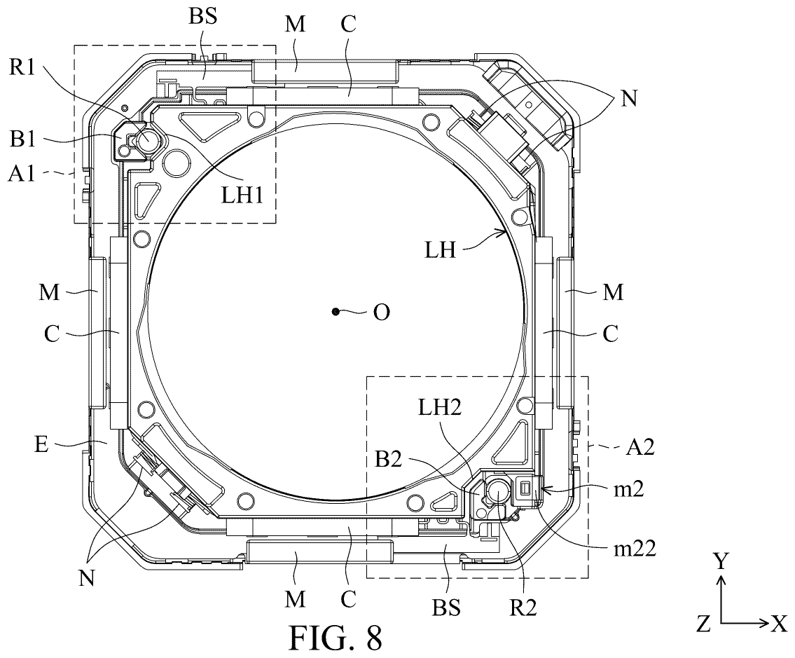

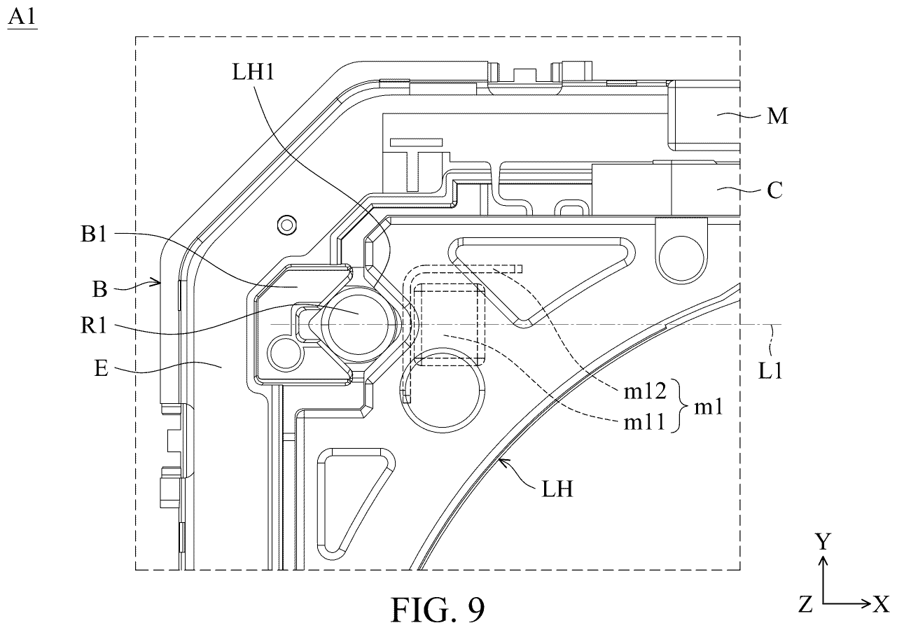

FIG. 8 is a top view of the driving mechanism 100 shown in FIGS. 3 and 4 with the housing H and the frame F removed therefrom. FIG. 9 is an enlarged view of the area Al in FIG. 8.

Referring to FIGS. 8 and 9, the first recessed portion LH1 of the holder LH has a V-shaped structure. The opening of the first recessed portion LH1 is oriented toward the-X direction, and the first guiding member R1 slidably contacts two sidewalls of the first recessed portion LH1.

Moreover, as shown in FIG. 9, the first magnetic unit m1 is hidden at a corner of the holder LH and located adjacent to the first guiding member R1 and the first recessed portion LH1. Specifically, the first shield m12 has an L-shaped structure and located between the first guiding member R1 and the first magnet m11, wherein a gap is formed between the first shield m12 and the first guiding member R1.

In this embodiment, the polar direction of first magnet m11 is parallel to the X axis (first axis). The line L1 extending through the centers of the first magnet m11 and the first guiding member R1 is also parallel to the X axis (perpendicular to the optical axis O). Hence, the first magnet m11 and the metal first guiding member R1 can produce a first magnetic attractive force that is parallel to the X axis, whereby the first guiding member R1 can be stably in contact with the sidewalls of the first recessed portion LH1 and prevented from being separated from the first recessed portion LH1.

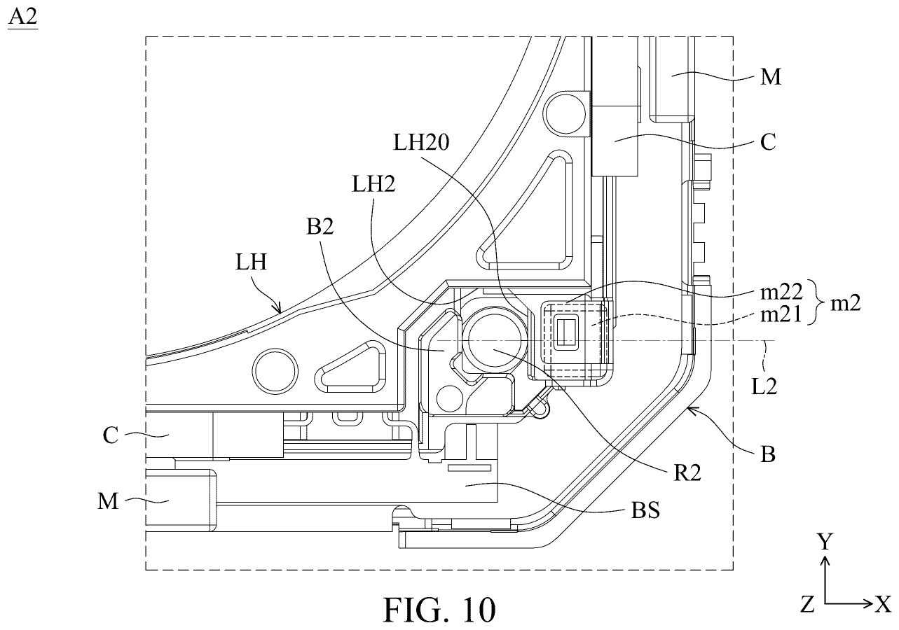

FIG. 10 is an enlarged view of the area A2 in FIG. 8. Referring to FIG. 10, the second recessed portion LH2 of the holder LH has an abutting surface LH20. The second guiding member R2 slidably contacts the abutting surface LH20 of the second recessed portion LH2, and a part of the second column B2 is received in the second recessed portion LH2.

Moreover, as shown in FIG. 10, the second magnetic unit m2 is disposed at another corner of the holder LH and located adjacent to the second guiding member R2 and the second recessed portion LH2. Specifically, the abutting surface LH20 of the second recessed portion LH2 is located between the second magnet m21 and the second guiding member R2, and a distance is formed between the second magnet m21 and the second guiding member R2.

In this embodiment, the polar direction of second magnet m21 is parallel to the X axis (second axis). The line L2 extending through the centers of the second magnet m21 and the second guiding member R2 is also parallel to the X axis (perpendicular to the optical axis O). Hence, the second magnet m21 and the metal second guiding member R2 can produce a second magnetic attractive force that is parallel to the X axis, whereby the second guiding member R2 can be stably in contact with the abutting surface LH20 of the second recessed portion LH2 and prevented from being separated from the second recessed portion LH2. Here, the abutting surface LH20 is a flat surface substantially perpendicular to the X axis (first axis).

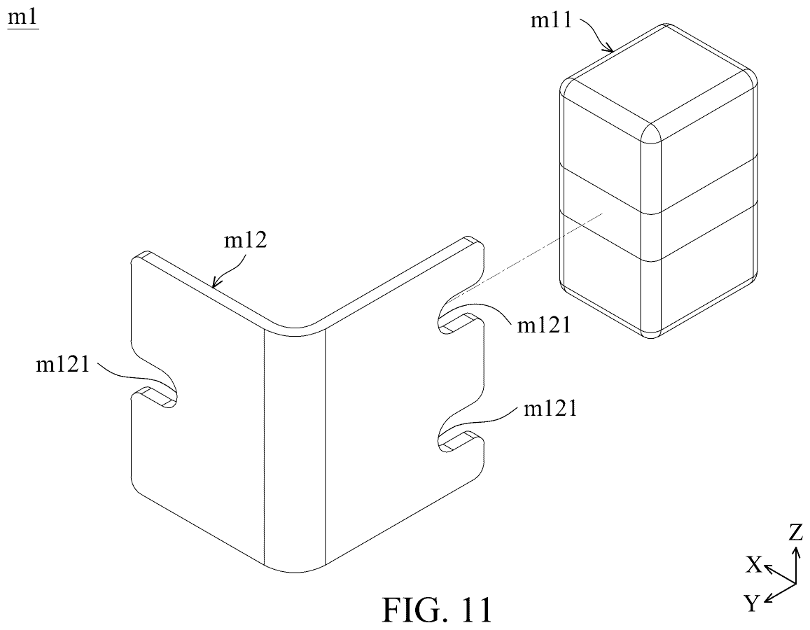

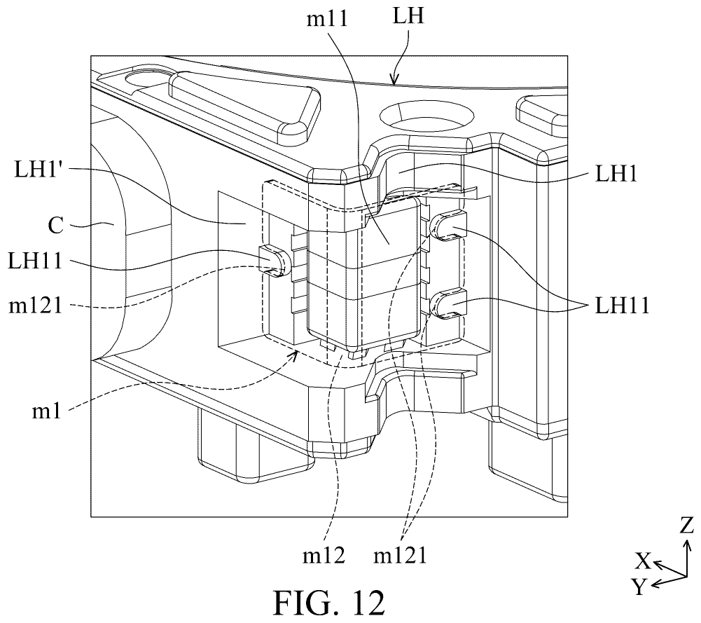

FIG. 11 shows an exploded view of the first magnetic unit m1. FIG. 12 is a perspective diagram showing the first magnetic unit m1 disposed in the first cavity LH1′ of the holder LH.

Referring to FIG. 11, the first magnetic unit ml includes a first magnet m11 and a first shield m12. The first shield m12 has an L-shaped structure, and a plurality of first slots m121 are formed on opposite edges of the first shield m12.

As shown in FIG. 12, the first cavity LH1′ is formed at a corner of the holder LH and located adjacent to the first recessed portion LH1. The first magnet m11 and the first shield m12 are received in the first cavity LH1′ to achieve miniaturization of the driving mechanism 100, wherein the first magnet m11 is concealed by the first shield m12.

In some embodiments, when viewed along the optical axis O, the first magnet m11 overlaps the holder LH but does not overlap the first shield m12. When viewed along the direction (e.g. X or Y direction) perpendicular to the optical axis O, the first magnet m11 overlaps the first shield m12, whereby the first magnet m11 can be protected by the first shield m12.

It should be noted that the holder LH forms a plurality of first protrusions LH11 that are located in the first cavity LH1′. During assembly of the driving mechanism 100, the first protrusions LH11 are respectively joined in the first slots m121 of the first shield m12, so as to prevent the first magnet m11 and the first shield m12 from being separated from the holder LH.

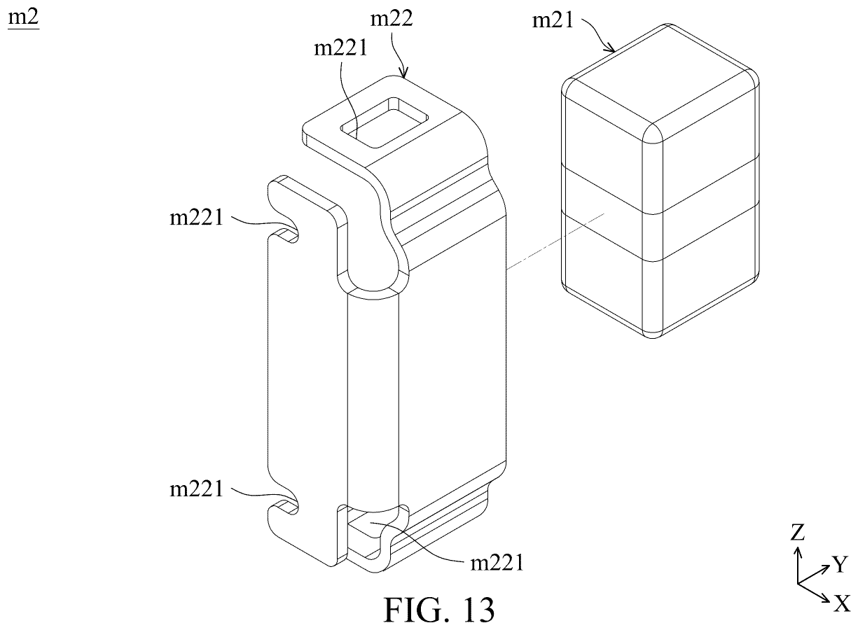

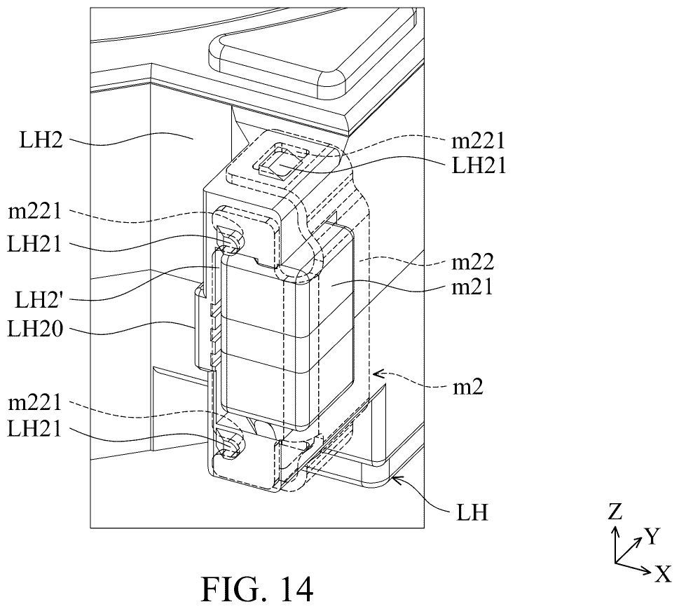

FIG. 13 shows an exploded view of the second magnetic unit m2. FIG. 14 is a perspective diagram showing the second magnetic unit m2 disposed in the second cavity LH2′ of the holder LH.

Referring to FIG. 13, the second magnetic unit m2 includes a second magnet m21 and a second shield m22. The second shield m22 has a U-shaped structure, and a plurality of second slots m221 are formed on the second shield m22.

As shown in FIG. 14, the second cavity LH2′ is formed at a corner of the holder LH and located adjacent to the second recessed portion LH2. The second magnet m21 and the second shield m22 are received in the second cavity LH2′ to achieve miniaturization of the driving mechanism 100. Here, the second shield m22 is disposed on the outer side of the second magnet m21 to protect and conceal the second magnet m21.

In some embodiments, when viewed along the optical axis O, the second magnet m21, the second shield m22, and the holder LH at least partially overlap. When viewed along the direction (e.g. X or Y direction) perpendicular to the optical axis O, the second magnet m21 overlaps the second shield m22, whereby the second shield m22 can protect the second magnet m21.

It should be noted that a plurality of second protrusions LH21 are formed on the outer surface of the holder LH. During assembly of the driving mechanism 100, the second protrusions LH21 are respectively joined in the second slots m221 of the second shield m22, so as to prevent the second magnet m21 and the second shield m22 from being separated from the holder LH.

In summary, the invention provides a driving mechanism 100 that has a first guiding member R1 and a second guiding member R2 disposed on the fixed part (base B). The driving mechanism 100 further has a first magnetic unit m1 and a second magnetic unit m2 disposed on the movable part (holder LH), corresponding to the first guiding member R1 and a second guiding member R2.

In some embodiments, the first magnet m11 of the first magnetic unit m1 and the first guiding member R1 can produce a first magnetic attractive force. Similarly, the second magnet m21 of the second magnetic unit m2 and the second guiding member R2 can produce a second magnetic attractive force. Therefore, the first and second guiding members R1 and R2 can be stably in contact with the holder LH and prevented from being separated from the movable part (holder LH), and the function of auto-focusing (AF) and Optical Image Stabilization (OIS) can be achieved to provide high quality of images even when the electronic device (e.g. cell phone or camera) is shaking.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification.

As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A driving mechanism for moving an optical element that has an optical axis, the driving mechanism comprising:
a fixed part;
a movable part, movably connected to the fixed part for holding the optical element; and
a driving assembly, configured for moving the movable part relative to the fixed part.

2. The driving mechanism as claimed in claim 1, further comprising a first guiding member disposed on the fixed part and connected to the movable part for guiding the movable part to move relative to the fixed part along the optical axis.

3. The driving mechanism as claimed in claim 2, further comprising a first magnet disposed on the movable part, wherein the movable part has a first recessed portion, and the first magnet and the first guiding member produce a first magnetic attractive force, whereby the first guiding member remains in contact with the first recessed portion.

4. The driving mechanism as claimed in claim 3, further comprising a first shield disposed on the movable part and concealing the first magnet, wherein the first shield is located between the first guiding member and the first magnet.

5. The driving mechanism as claimed in claim 4, wherein the first shield comprises metal with low magnetic permeability.

6. The driving mechanism as claimed in claim 4, wherein a gap is formed between the first shield and the first guiding member.

7. The driving mechanism as claimed in claim 4, wherein the movable part further has a first protrusion, the first shield has a first slot, and the first protrusion is joined in the first slot.

8. The driving mechanism as claimed in claim 4, wherein the first magnet comprises a monopolar, bipolar or multipolar magnet.

9. The driving mechanism as claimed in claim 8, wherein the polar direction of the first magnet is parallel to a first axis that is perpendicular to the optical axis.

10. The driving mechanism as claimed in claim 9, wherein a line extending through the centers of the first magnet and the first guiding member is parallel to the first axis.

11. The driving mechanism as claimed in claim 3, wherein the first recessed portion of the holder has a V-shaped structure.

12. The driving mechanism as claimed in claim 11, further comprising a second guiding member disposed on the fixed part and connected to the movable part for guiding the movable part to move relative to the fixed part along the optical axis, wherein the first and second guiding members are located at opposite corners of the fixed part.

13. The driving mechanism as claimed in claim 12, further comprising a second magnet disposed on the movable part, wherein the movable part has a second recessed portion, and the second magnet and the second guiding member produce a second magnetic attractive force, whereby the second guiding member remains in contact with an abutting surface of the second recessed portion.

14. The driving mechanism as claimed in claim 13, further comprising a second shield disposed on the movable part and concealing the second magnet, wherein the abutting surface is located between the second guiding member and the second magnet.

15. The driving mechanism as claimed in claim 14, wherein the movable part further has a second protrusion, the second shield has a second slot, and the second protrusion is joined in the second slot.

16. The driving mechanism as claimed in claim 13, wherein the polar direction of the first and second magnets is parallel to the first axis and perpendicular to the optical axis.

17. The driving mechanism as claimed in claim 16, wherein the abutting surface is a flat surface perpendicular to the first axis.

18. The driving mechanism as claimed in claim 13, wherein the fixed part has a first column and a second column, the first guiding member is affixed to the first column, and the second guiding member is affixed to the second column.

19. The driving mechanism as claimed in claim 18, wherein the first column and the second column are located at opposite corners of the fixed part.

20. The driving mechanism as claimed in claim 19, wherein at least a part of the second column is received in the second recessed portion.
